(19) United States
(12) Patent Application Publication
(10) Pub. No.: US 2010/0253070 A1
(43) Pub. Date: Oct. 7, 2010

(54) COUPLING WITH AUTOMATIC SEAL

(76) Inventors: Peter CHEON, Aubum, WA (US); AnKuk Song, AnYang-Shi (KR); EungSoon Lee, AnYang-Shi (KR); Tim Hunting, Aubum, WA (US)

Correspondence Address: DWC LAW FIRM, P.S., P.O. BOX 3041, SEATTLE, WA, 98114-3041, US

(21) Appl. No.: 12/715,375

(22) Filed: Mar. 1, 2010

Related U.S. Application Data
(63) Continuation-in-part of application No. 11/772,206, filed on Jun. 30, 2007, now abandoned.

(51) Int. Cl. F16L 55/00; F16L 39/00

(52) U.S. Cl. 285/148.1; 285/318

(57) ABSTRACT

A conduit coupling can have a male portion and a female portion, with each portion having an internal biasing member. When the male portion is disconnected from the female portion, the internal biasing member in the male portion can cause a seal on a moveable plug to be biased against a lip of a stationary wall member to seal liquid from leaking out of the male portion. Also, the internal biasing member in the female portion can cause a lip of a moveable wall member to be biased against a seal that is connected to a stationary plug and can simultaneously cause a seal on the movable wall member to be biased against a wall of the female portion, to simultaneously seal liquid from leaking out of the female portion at two separate contact locations.

### RELATED APPLICATION (S)

This application is a continuation-in-part of U.S. patent application Ser. No. 11/772,206, filed Jun. 30, 2007, which is incorporated herein by reference in its entirety.

### BACKGROUND

1. Field of the Invention

The present invention relates to couplings, and more particularly, to couplings having spring loaded sealing capabilities for use in liquid transport conduit systems.

2. Description of Related Art

Conduit systems for transporting fluid, such as, for example, flexible tube systems for transferring liquids, often include stand-alone couplings. There couplings allow users to, among other things, install, maintain or replace discrete and separate conduit sections.

A variety of such couplings are known in the art. For example, U.S. Pat. No. 5,104,158 to Meyer et al., discloses a quick connecting/disconnecting coupling, that includes a female and male coupling member, each having a flow path through which fluid can flow. The coupling has a quick connecting/disconnecting clip member that is slidably mounted on the female coupling member and slidable between a connecting position and a disconnecting position. Although the patent discloses a seal when the male and female coupling members are connected, there is no seal when they are disconnected. As such, pressurized fluid is free to leak from the coupling members when they are disconnected.

In the coupling discussed in U.S. Pat. No. 5,104,158, used to connect flexible tubes, automatic sealing is provided upon disconnection of the coupling to prevent discharge of fluids. However, the connection/disconnection mechanism is complicated, a biasing member is unprotected and exposed to external contact, and a release clip may introduce risk of accidental disconnection of the coupling, which could result in leaks. Additionally, residual liquid can leak from a coupling when it is intentionally disconnected.

### BRIEF SUMMARY OF THE INVENTION

Various embodiments of the present invention provide a conduit coupling for use with fluid conduits that comprise a male portion having a fluid passage and female portion having a fluid passage. The male portion can be connectable to the female portion, and releasably locked together by twisting the portions relative to one another to provide a unified fluid passage through the conduit coupling.

The male portion and female portion can each having an internal biasing member for providing an automatic seal when the portions are disconnected from one another. That is, the internal biasing members can push annular sealing members against walls within each of the male portion and female portion, to seal the respective portions from discharging fluid when they are disconnected.

For example, in some embodiments of the coupling of the present invention, a first portion (such as, for example, a male portion) of the coupling has a first biasing member positioned to bias a movable channel member positioned within a first fluid chamber. The movable channel member can have a first plug portion with a seal member connected to the first plug portion. A second portion (such as, for example, a female portion) of the coupling can have a second biasing member positioned to bias a movable wall member. The movable wall member can have a seal connected to an outer surface of the movable wall member. When the first portion and the second portion are disconnected, the first biasing member biases the movable channel member to a position such that the seal member connected to the first plug portion is aligned with a first interior wall. Also, the second biasing member biases the movable wall member to a position such that the seal connected to the outer surface of the movable wall member is compressed against a contact surface.

In some embodiments, the conduit coupling can have one or more non-linear tracks on the female portion for use in releasably and securely locking the female portion to the male portion. Corresponding lock members formed on the male portion, such as stubs, can be insertable into the tracks and movable in a non-linear fashion within the tracks to lock the male portion in a connected position with the female portion.

### BRIEF DESCRIPTION OF THE DRAWINGS

FIG. 1 is a perspective view of an embodiment of a coupling of the present invention.

FIG. 2 is a cross sectional view of the coupling of FIG. 1, showing the male coupling portion and female coupling portion in a connected position.

FIG. 3 is a cross sectional view of the coupling of FIG. 2, showing the male coupling portion and female coupling portion in a disconnected position.

FIG. 4 is a perspective exploded view showing components of the female coupling portion of FIG. 1.

FIG. 5 is a perspective exploded view showing components of the male coupling portion of FIG. 1.

FIG. 6 is a side elevation view of the coupling of FIG. 1.

FIG. 7 is simplified side elevation view of the flange portion of the female coupling portion of FIG. 6, showing an interaction between a stub and a track of a releasable lock for the present invention.

FIG. 8 is an exploded perspective view of a female portion of an alternative embodiment of a coupling of the present invention, the female portion being shown connected to a male portion of the coupling in FIG. 12.

FIG. 9 is a side cross sectional view of the female portion of the coupling shown in FIG. 8.

FIG. 10 is an exploded perspective view of a male portion of the coupling shown in FIG. 12.

FIG. 11 is a side cross sectional view of the male portion of the coupling shown in FIG. 10.

FIG. 12 is a side cross sectional view of an embodiment of a coupling of the present invention, showing the female portion of FIG. 8 connected to the male portion of FIG. 10.

### DETAILED DESCRIPTION OF PREFERRED EMBODIMENTS

In the following description, certain specific details are set forth in order to provide a thorough understanding of various embodiments of the invention. However, upon reviewing this disclosure, one skilled in the art will understand that the invention may be practiced without many of these details. In other instances, well-known structures related to tubes, conduits, springs and materials of construction have not been described in detail to avoid unnecessarily obscuring the descriptions of the embodiments of the invention.

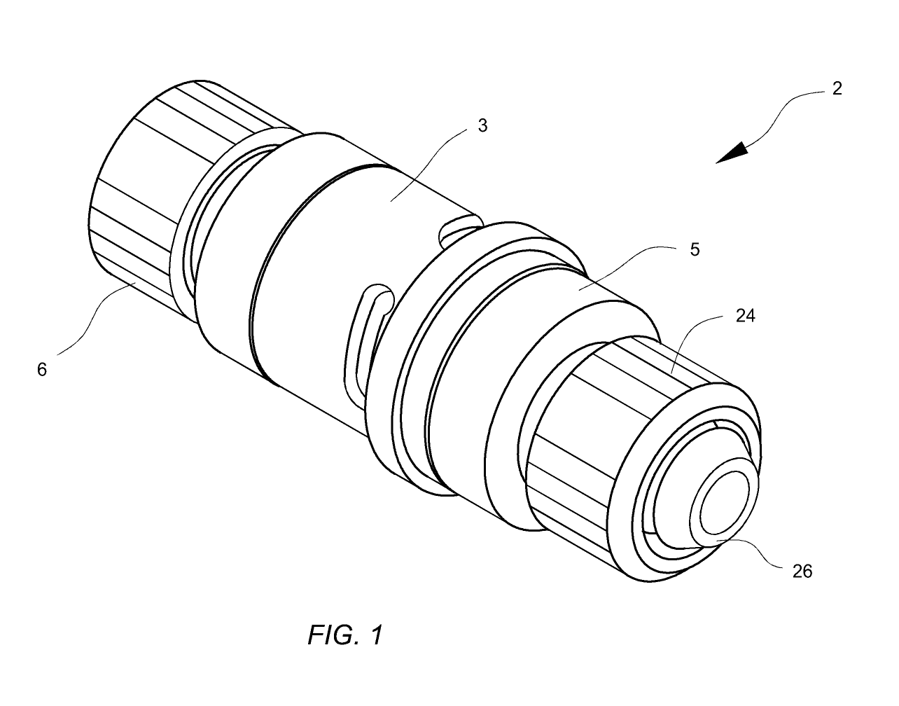

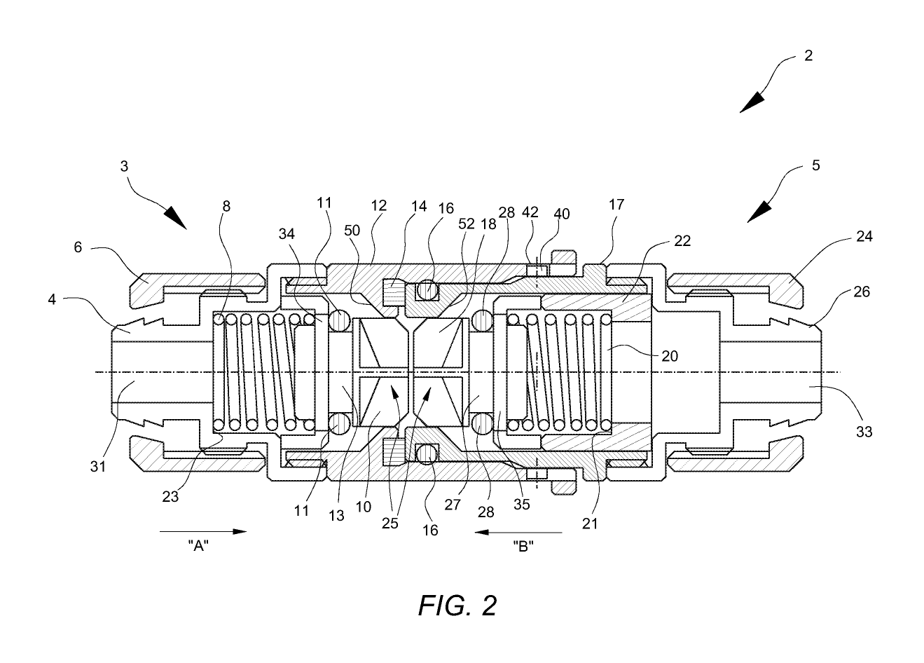

FIG. 1 shows an embodiment of the coupling 2 of the present invention, having a female portion 3 and a male portion 5, with end caps 6, 24 and tube connector 26 on the male portion (a tube connector 4 is visible on the female portion in FIG. 2).

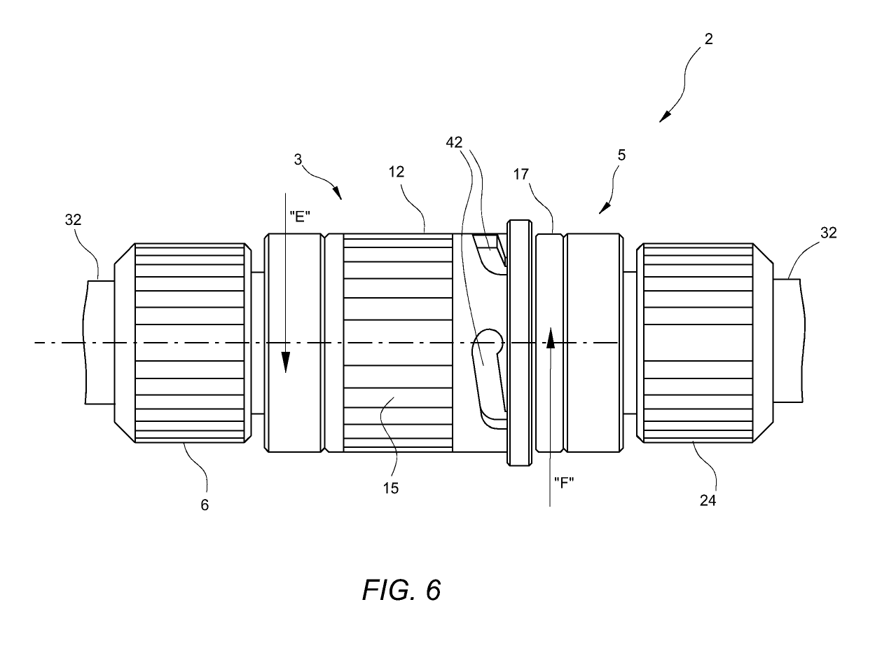

Referring to FIG. 6, conduit sections 32, such as flexible tube sections, can be sealably connected to the conduit coupling 2 and locked in place using end caps 6, 24.

Now referring to FIGS. 2 & 3, each of the coupling portions, female portion 3 and male portion 5, has an interior fluid channel that can pass over channel members (or valves) 10, 18 within the fluid channel, to allow fluid to flow through the coupling 2. Each of the coupling portions 3, 5 also has a biasing member 8, 20, which can be a coil spring in some embodiments of the present invention. The biasing members 8, 20 are set adjacent interior retaining walls 23, 21 of the respective female portion 3 and male portions 5, as can be seen in FIG. 2.

The biasing members 8, 20 provide biasing force against the channel members 10, 18 in the directions of arrows “A” and “B” respectively, and against annular seals 11, 28, which can be O-ring seals that circumferentially surround neck portions 13, 27 of the channel members 10, 18. As can be seen from FIGS. 2 & 4 in combination, the neck portions 13, 27 of the channel members 10, 18 can be circular.

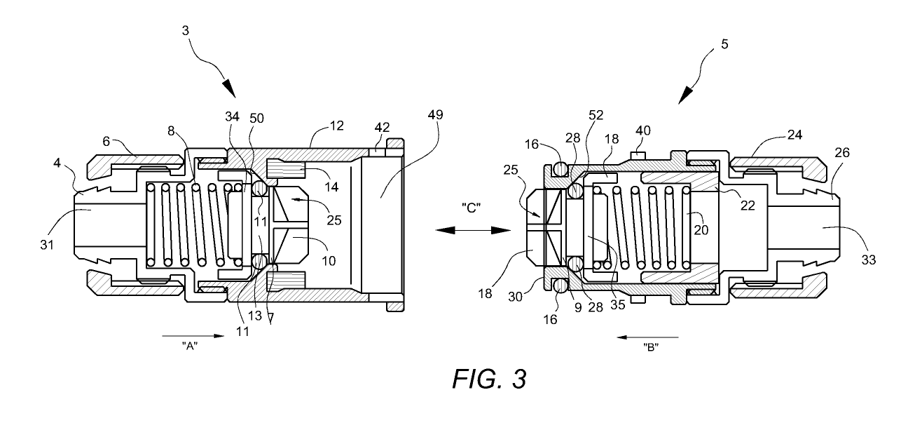

As best seen in FIG. 3, showing the coupling 2 in a disconnected position, when the annular seals 11, 28 are freely biased in the direction of arrows “A” and “B” respectively, the annular seals 11, 28 are compressed against sealing walls 50, 52 of the female portion 3 and male portion 5, respectively. However, when an inward section 30 of the male portion 5 is manually inserted into a receiving chamber 49 of the female portion 3 in the direction of arrow “C,” end portions of the channel members 10, 18 abut and apply force against the biasing members 8, 20 to cause each of the channel members 10, 18 to recede in an opposite direction from the approaching channel member. This, in turn, causes the annular seals 11, 28 to recede away from the sealing walls 50, 52 until they come to rest in their respective positions shown in FIG. 2. FIG. 2 is reflective of the connected position for the coupling 2.

As will be appreciated by one skilled in the art after reviewing this disclosure, the disconnected position shown in FIG. 3, provides an automatic seal via the compression of the annular seals 11, 28 against the sealing walls 50, 52. Fluid in the female portion 3 and male portion 5 of the coupling 2, which has entered into the coupling portions via fluid passage 31 or 33 (one of which is an entrance to the coupling 2, and one of which is an exit from the coupling 2, depending on direction of flow), is sealed from being discharged. As such, a sudden release of liquid from the coupling due to pressure drop from disconnecting the coupling and exposing it to atmospheric pressure, can be substantially prevented.

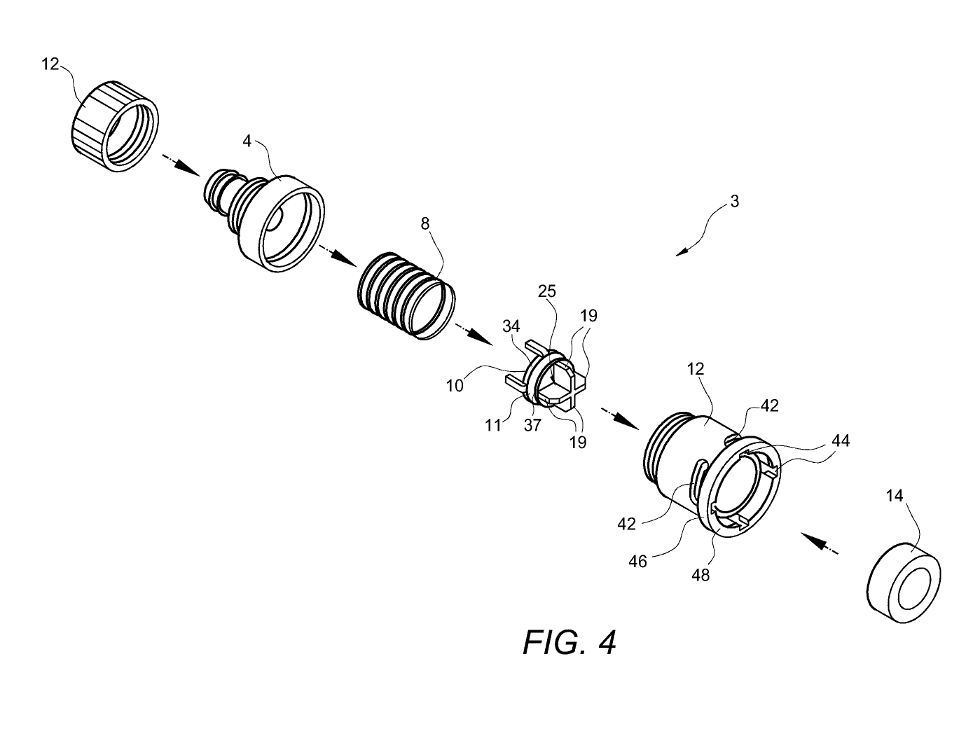

A releasable lock assembly can be provided for locking the female portion 3 to the male portion 5. First, referring to FIG. 4, the female portion 3 is provided with tracks 42 that extend through a wall of the female portion 3, near a flange 46. The tracks 42 also extend beneath a section of the flange 46, as best seen in FIG. 4. As such, track entrances 44 can be seen on the face 48 of the flange 46.

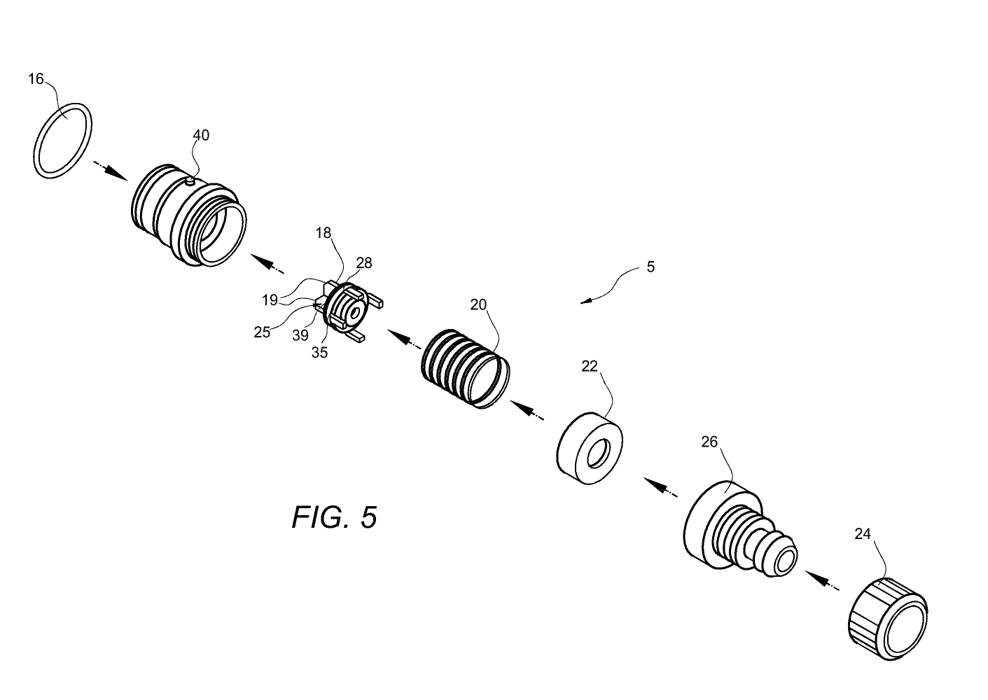

The tracks 42 are configured to receive stub members 40 of the male portion 5. A stub member 40 can be seen in FIG. 5. Multiple stub members 40 can be provided on the male portion 5 and multiple corresponding tracks 42 can be provided on the female portion 3, as will be appreciated by those skilled in the art after reviewing this disclosure.

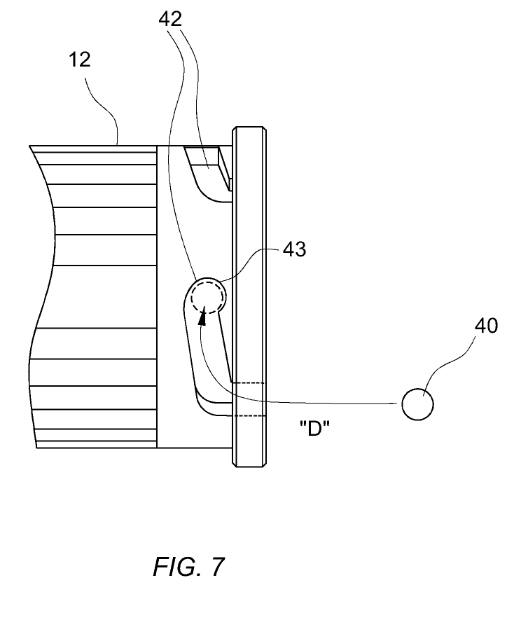

When an inward section of the male portion 5 is inserted into the receiving chamber 49 of the female portion 3, one or more stub members 40 on the male portion 5 can be aligned with one or more corresponding track entrances 44, such that the stub members 40 can be pushed into the track 42, in the direction of arrow “D,” as shown in FIG. 7. Arrow “D” moves forward into the track 42, then circumferentially across with respect to the surface of the female portion 3, then slightly back into a resting gap 43, to securely hold and releasably lock the male portion 5 in a connected position with the female portion 3. This can be accomplished by manually pushing the coupling portions 3, 5 together, then twisting them with respect to one another in the directions represented by arrows “E” and “F” shown in FIG. 6, then allowing the biasing members 8, 20 to bias the female and male portion away from each other slightly to push a stub members 40 back into the resting gaps 43. The coupling portions can be unlocked from one another by moving them in the opposite direction of arrow “D,” to disconnect the female portion 3 and male portion 5 from one another. In some embodiments of the present invention, an outer grip member 15 is provided, which can be a grill-like surface to allow a user to grip the coupling 2 to turn it during locking and releasing.

When the female portion 3 and male portion 5 are in the connected position, as shown in FIG. 2, the annular seals 11, 28 are receded from the sealing walls 50, 52 respectively. Also, the channel members 10, 18 are receded inward into the respective female and male portions. As such, fluid can flow past the annular seals 11, 18 and past wedge gaps 25 of the channel members 10, 18. The wedge gaps 25 are formed between fins 19 (shown in FIGS. 4, 5) of the channel members 10, 28 and provide sufficiently large gaps for fluid to flow through to reduce pressure drop across the coupling 2. The fins 19 of each channel member 10, 18 can be planar walls aligned in parallel with a longitudinal axis of the conduit coupling 2, and can be connected to a circular wall 37, 39 of each channel member. When the conduit portions 3, 5 are disconnected, the channel members 10, 18 can be positioned such that their respective circular walls 37, 39 are substantially and snugly aligned with an opening of the respective sealing walls 50, 52. When the conduit portions 3, 5 are connected, the respective wedge gaps 25 of the channel members are aligned with the openings of the respective sealing walls 50, 52 to allow fluid to flow through the wedge gaps.

Furthermore, as can be seen in FIG. 2, when the coupling portions 3, 5 are connected, a sponge ring 14 of the female portion 3 is compressed against an inwardly facing wall of the male portion 5, and an annular connection seal 16 of the male portion 5 is compressed against an inside wall of the receiving chamber 49 of the female portion. As will be appreciated by those skilled in the art, the annular connection seal can prevent higher-pressure fluid inside the coupling 2 from leaking out of the coupling during use when the coupling is in a connected position. Also, the sponge ring 14 (also shown in FIGS. 3 & 4) can have absorbent characteristics, and can thus help absorb residual fluid in, for example, the receiving chamber 49 when the female portion 3 and male portion 5 are disconnected, thus further preventing fluid from spilling when the female and male portions are disconnected. The decompression of the sponge ring 14 when the female portion 3 is disconnected from the male portion 5 can allow the sponge ring to expand and absorb liquid.

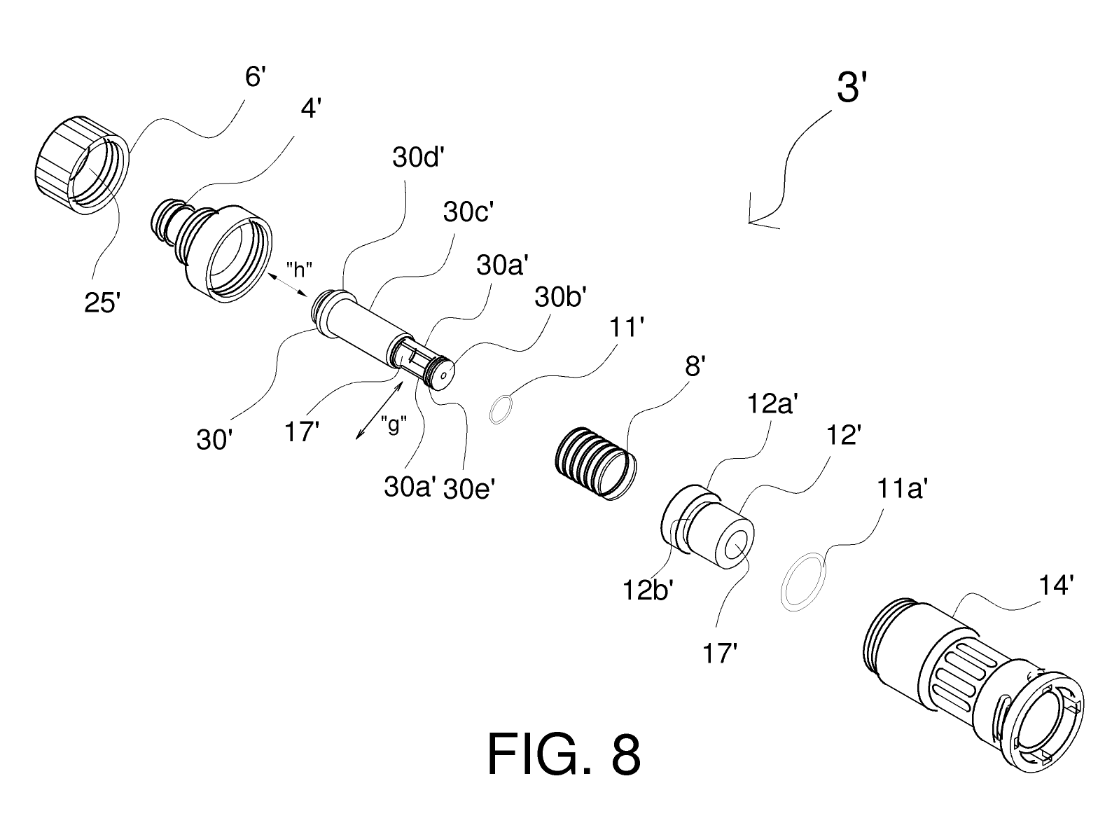

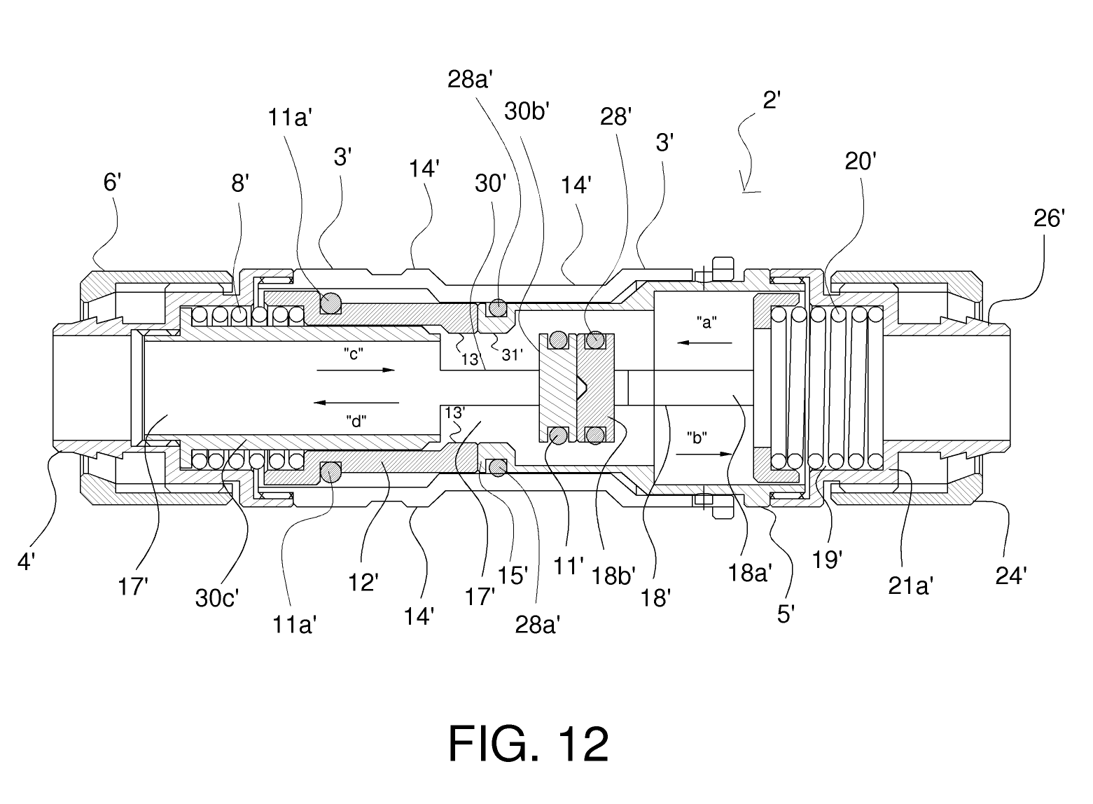

Now, turning to another embodiment of the present invention, FIG. 12 illustrates another embodiment of the coupling 2′ of the present invention, having a female portion 3′ and a male portion 5′. FIGS. 8 & 10 show exploded views of embodiments of female portion 3′ and male portion 5′. Each portion 3′, 5′ includes a respective tube connector 4′ & 26′ formed on an outside end of the portion. Each of the portions 3′, 5′ can include an end cap 6′, 24′ which is threadably attachable to the respective portion 3′, 5′. Flexible tubes (not illustrated), or other types of fluid conduits in some embodiments, can be sealably connected to the each of the tube connectors 4′ & 26′ and, as best seen in FIGS. 8 & 10, the flexible tube sections (not illustrated) can be threaded through central holes 25′ in the end caps 6′, 24′, and the end caps can be screwed onto end portions of the respective female portions 3′ and male portion 5′ to secure the tube sections to the tube connectors 4′ & 26′.

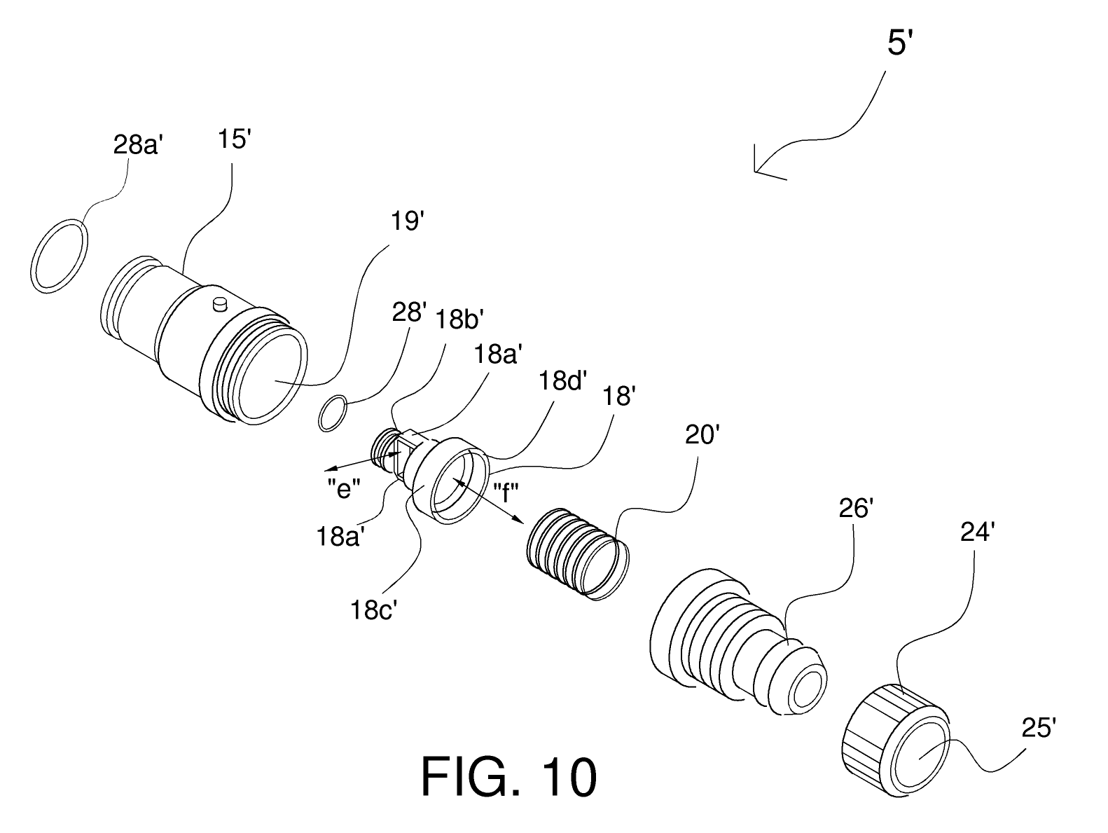

Referring to FIGS. 10 & 11, the male portion 5′ of conduit 2′ has fluid chamber 19′ which serves as an interior fluid channel. Fluid chamber 19′ also contains first biasing member 20′, and liquid can flow through the fluid chamber 19′, including through an axial space of the first biasing member 20′. First biasing member 20′ can be a coil spring which rests within the fluid chamber 19′, with the fluid chamber 19′ being cylindrical in shape.

The outer circumferential edges of the coils of biasing member 20′ can rest against the internal walls 19a′ of the fluid chamber 19′.

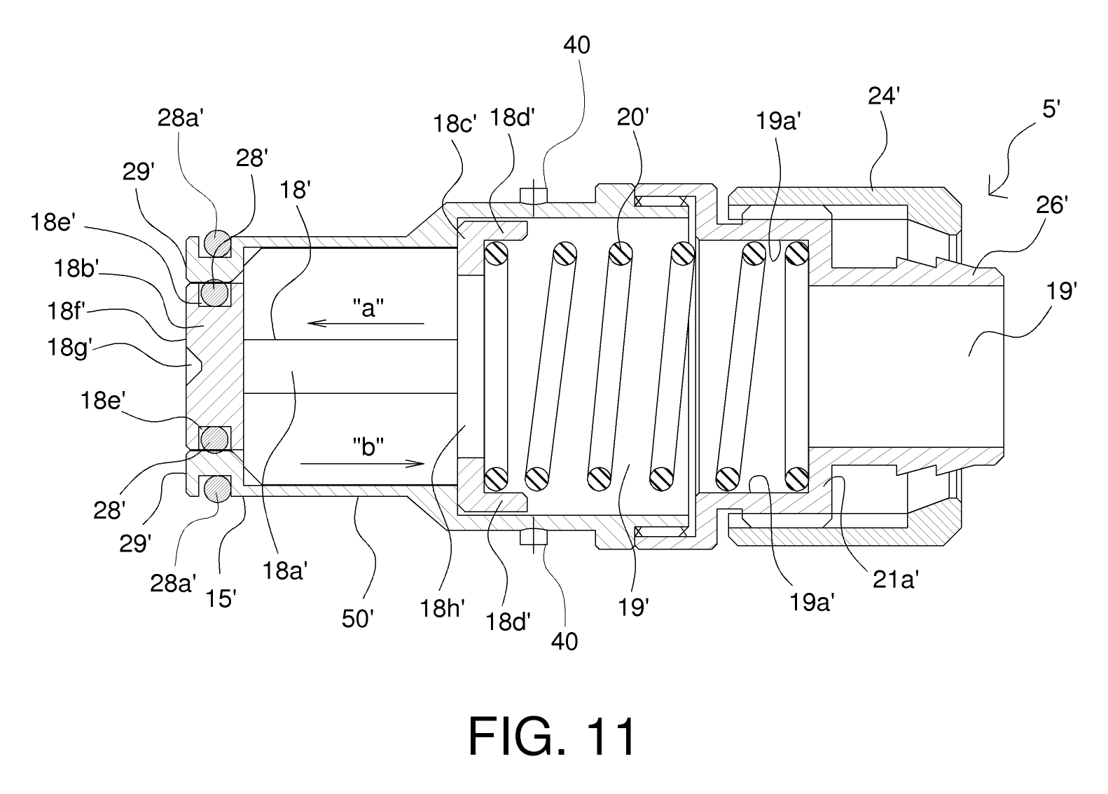

A movable channel member 18′, to which a plug portion 18b′ is attached, can be positioned within a portion of the fluid chamber 19′. The movable channel member 18′ includes a channel retainer 18c′. As best seen in FIG. 11, the channel retainer 18c′ can be positioned adjacent the biasing member 20′, with a circumferential wall 18d′ (or outer wall) of the channel retainer 18c′ extending in an axial (or longitudinal) direction of the fluid chamber 19′ to surround an end portion of the biasing member 20′, such that the outer circumferential edge of at least one coil of the biasing member 20′ can rest against an interior surface of the circumferential wall 18d′ of the channel retainer 18c′. An opposite end portion of the biasing member 20′ can abut against a laterally extending retaining wall 21a′, which is stationary to prevent movement of the biasing member 20′ beyond the laterally extending retaining wall 21a′. As best seen in FIG. 10, the movable channel member 18′ can also include two or more extension strips 18a′, which can be positioned on opposite sides of the movable channel member 18′, and which connect the channel retainer 18c′ to the plug portion 18b′ of the movable channel member 18′. The channel strips 18a′ allow fluid to flow through gaps between the strips 18a′ to either exit from the gaps or enter into the gaps, as generally illustrated by arrow “e,” and through a passageway 18h′ of the movable channel member 18′ (See, FIG. 11), to enter or exit from an opposite end portion of the moveable channel member 18′, as generally illustrated by arrow “f.”

Referring to FIG. 11, the plug portion 18b′ of the movable channel member 18′ includes an annular recess 18e′ positioned on the outer sidewall thereof, within which can rest a first annular seal 28′ (such as a seal ring). The annular seal 28′ can be made of a compressible elastic material, such as, without limitation, an elastomer.

Referring to FIGS. 8 & 9, the female portion 3′ of conduit 2′ has fluid chamber 17′ which serves as the interior fluid channel. The inner wall surface of the fluid chamber 17′ is comprised partly of the interior wall of a movable wall member 12′ and partly of the interior wall of a stationary channel member 30′. Both the movable wall member 12′ and stationary channel member 30′ can be contained within an outer wall 14′ of the female portion 3′ of the coupling 2′. A hollow shaft 30c′ of the stationary channel member 30′ can be cylindrical with the interior of the shaft 30c′ forming part of the fluid chamber 17′. A biasing member 8′ (such as, for example, a coil spring) can be coiled about the shaft 30c′ on an outside wall of the shaft 30c′. An first end portion of the biasing member 8′ can abut against an outwardly extending annular flange 30d′, formed on an outside wall of the shaft 30c′, to prevent the biasing member 8′ from slipping past the flange 30d′. (“Outwardly” in this context refers to a direction extending radially outward away from a central axis of the conduit coupling 2′). A second end portion of the biasing member 8′ can be mated against a lateral surface of the movable wall member 12′, within a cup portion 12a′ of the movable wall member 12′, to bias the movable wall member 12′ toward the male portion 5′ of the coupling 2′, or inwardly (“Inwardly” in this context refers to a direction toward the other portion, such as the male portion 5′, of the conduit coupling 2′).

The stationary channel member 30′ can include extension strips 30a′, which connect the shaft 30c′ to a plug portion 30b′ . In the illustrated embodiments, there are two extension strips 30a′, positioned on opposite sides of the stationary channel member 30′, with the extension strips 30a′ being generally aligned with a portion of the wall of the shaft 30c′, as best seen in FIG. 8. Fluid can flow into, or out of, an outer end of the shaft 30c′, as illustrated by arrow “h” in FIG. 8, and enter or exit the opposite end of the shaft 30c via gaps between the extension strips 30a, as illustrated by arrow “g” in FIG. 8.

The plug portion 30b′ of the stationary channel member 30′ includes an annular recess 30e′ positioned on the outer sidewall thereof, within which can rest a second annular seal 11′ (such as a seal ring). The second annular seal 11′ can be made of a compressible elastic material, such as, without limitation, an elastomer.

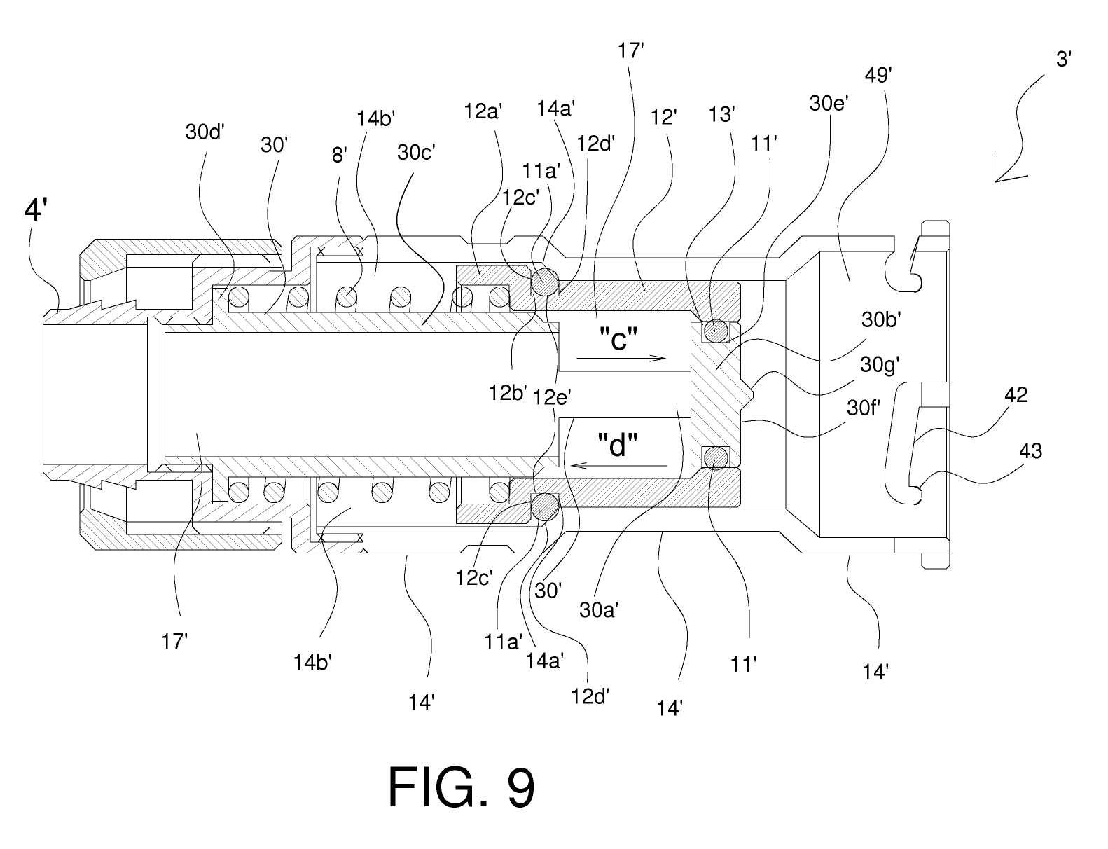

Referring now to FIGS. 9, 11 & 12, in some embodiments of the present invention, an inward portion of the male portion 5′ can be manually inserted into a receiving chamber 49′ of the female portion 3′. The plug portion 30b′ of the female portion 3′, which is stationary with respect to the female portion, can abut against the plug portion 18b′ of the male portion 5′, which is movable with respect to the male portion. Also, a lip 29′ on the outer wall 15′ of the male portion 5′ which enters the receiving chamber 49′ of the female portion 3′ can abut against the movable wall member 12′ of the female portion 3′. As the female portion 3′ and male portion 5′ are pushed together, the plug portion 18b′ of the male portion 5′ is forced to move in the direction of arrow “b” (See FIG. 11) by being pushed by the stationary plug portion 30b′ of the female portion and the movable wall member 12′ of the female portion 3′ is forced to move in the direction of arrow “d” (See FIG. 9) by being pushed by the outer wall 15′ of the male portion 5′. The beginning positions of the plug portion 18b′ and the movable wall member 12′, before the male portion 5′ and female portion 3′ are connected, are shown in FIGS. 9 & 11, and the end positions of the plug portion 18b′ and the movable wall member 12′, after the male portion 5′ and female portion 3′ are fully connected, are shown in FIG. 12. As can be seen in FIG. 12, the biasing members 8′, 20′ of the respective female and male portions, 3′, 5′, are thereby compressed through movement of the plug portion 18b′ and movable wall member 12′. The male portion 5′ and female portion 3′ can be removably locked together by a locking assembly, such as, for example, without limitation, the lock assembly described above for the embodiment of the coupling 2 shown in FIG. 1. That is, for example, the tracks 42 and resting gaps 43 can be provided on the female portion 3′, as can be seen in FIG. 9, and the male portion 5′ can have stubs 40, as can be seen in FIG. 11, suited for engaging the track 42 and resting gaps 43.

When the female portion 3′ and male portion 5′ are locked together, fluid can flow into one of the tube connectors 4′, 26′, through the fluid chambers 17′, 19′, and through gaps between the extension strips 30c′, 18a′, to pass through an opposite tube connector 4′, 26′. The flow path is opened when the male portion 5′ and female portion 3′ are connected, in part, because the first annular seal 28′, on the male portion 5′, is displaced inward in the direction of arrow “b,” as shown in FIGS. 11 & 12, away from being in contact and compressed against an inside wall 31′ of an entrance lip 29′ of the male portion 5′, and, in part, because an interior contact wall 13′ of the movable wall member 12′, is displaced in the direction of arrow “d,” as shown in FIGS. 9 & 11, away from being in contact with and compressing the second annular seal 11′. Again, the displaced positions of the first annular seal 28′ and interior contact wall 13′ of the movable wall member 12′ are illustrated in FIG. 12, wherein the male portion 5′ and female portion 3′ are shown in a connected position.

It is also noted that, in some embodiments of the present invention, the forward facing surfaces of the respective plug portions 18b′ and 30b′, have flat portions 18f′, 30f′ (See, e.g., FIGS. 9 & 11) with the flat portions being in substantial parallel alignment with respect to one another. Also, a conically shaped recess 18g′ is formed on the flat surface 18f′ of the plug portion 18b′ of the male portion 5′, and laterally aligned with a conically shaped protrusion 30g′ that is formed on the flat surface 30f′ of the plug portion 30b′ of the female portion 3′. When the female portion 3′ is connected to the male portion 5′, the flat portions 18f′ & 30f′ of the plug portions 18b′ & 30b′ are mated flush against one another, with the conically shaped protrusion 30g′ fitting snuggly within the conically shaped recess 18g′. This helps guide the plug portions during disconnection of the conduit 2′ and leaves little or no room for fluid to be trapped between the plug portions 18b′ & 30b′ when the male portion 5 is disconnected from the female portion 3′. That is, as can be seen in FIG. 12, when the male portion 5′ is being disconnected from the female portion 3′, and the two portions are pulled apart from one another, the plug portions 18b′ & 30b′ stay flush with one another as plug portion 18b′ is biased in the direction of arrow “a” by biasing member 20′ and the movable wall member 12′ is biased in the direction of arrow “c” by biasing member 8′. Eventually, as the male portion 5′ continues to be pulled apart from the female portion 3′, the first annular seal 28′ will come to be laterally aligned with and in contact with the inside wall 31′ of entrance lip 29′ to compress the seal 28′, as shown in FIG. 11. Also, an interior contact wall 13′ of the movable wall member 12′ will come to be longitudinally aligned and in contact with the second annular seal 11′ to compress the seal 11′, as shown in FIG. 9. Only then will biasing members 8′, 20′ be extended to the full extent permitted by the structural restrictions on the biasing members imposed by the female portion 3′ and male portion 5′, allowing the plug portions 18b′ and 30b′ to be separated from being flush against one another. This helps to ensure that no liquid has been trapped between the female portion 3′ and male portion 5′ to prevent leaking or spillage when the portions are disconnected for maintenance, conduit reconfiguration or disassembly, etc., as will be appreciated by those skilled in the art after reviewing this disclosure.

It is also noted that female portion 3′ can comprise at least one other seal 11a′ (e.g., annular seal member or seal ring), as shown in FIG. 9, which is retained on an outward end portion of the moveable wall member 12′ within an annular recess 12b′, the annular recess 12b′ being located on a radially outer surface of the moveable wall member 12′. The annular recess 12b′ is defined by two parallel facing lateral walls 12c′ and 12d′ and a bottom wall 12e′. Each of these walls, 12c′, 12d′, and 12e′, extends about a circumferential perimeter of the movable wall member 12′. The inwardly positioned lateral wall 12d′ (“inwardly positioned” in this context means positioned closer inward toward the male portion 5′) is shorter in radial length than the outwardly positioned lateral wall 12c′. As such, the outwardly positioned lateral wall 12c′ extends radially outward away from a longitudinal axis of the female portion 3′ further than, or is taller than, the inwardly positioned lateral wall 12d′. The annular seal member 11a′ can be wedged between the inwardly positioned lateral wall 12d′ and outwardly positioned lateral wall 12c′. The outer wall 14′ of the female portion 3′ includes an interior contact surface 14a′ that extends radially and diagonally inward with respect to a longitudinal axis of the female portion 3, as shown in FIG. 9. A surface portion of the annular seal member 11a′ is exposed above, or radially beyond, the inwardly positioned lateral wall 12d′, as best seen in FIG. 9, so as to expose the surface portion of the annular seal member 11a′ to the contact surface 14a′. That is, for example, when the female portion 3′ is disconnect from the male portion 5′, from the position shown in FIG. 12 to the position shown in FIG. 9, the movable wall member 12′ is pushed in the direction generally represented by arrow “c,” by biasing member 8′, until the exposed surface of the annular seal member 11a′ is compressed against the contact surface 14a′, as shown in FIG. 9. This restricts the movable wall member 12′ from being biased further toward the male portion 5′ and seals any liquid within a chamber space 14b′ between the hollow shaft 30c′ and outer wall 14′ that may be trapped in the chamber space.

Although specific embodiments and examples of the invention have been described supra for illustrative purposes, various equivalent modifications can be made without departing from the spirit and scope of the invention, as will be recognized by those skilled in the relevant art after reviewing the present disclosure. The various embodiments described can be combined to provide further embodiments. The described devices and methods can omit some elements or acts, can add other elements or acts, or can combine the elements or execute the acts in a different order than that illustrated, to achieve various advantages of the invention. These and other changes can be made to the invention in light of the above detailed description.

In general, in the following claims, the terms used should not be construed to limit the invention to the specific embodiments disclosed in the specification. Accordingly, the invention is not limited by the disclosure, but instead its scope is determined entirely by the following claims.

What is claimed is:

1. A conduit coupling for a fluid comprising:
a first portion having a first biasing member positioned to bias a movable channel member positioned within a first fluid chamber, the movable channel member including a first plug portion and a seal connected to the first plug portion;
a second portion having a second biasing member positioned to bias a movable wall member, the movable wall member having a seal connected to an outer surface of the movable wall member; and
the first portion being releasably connectable to the second portion wherein when the first portion and the second portion are disconnected, the first biasing member biases the movable channel member to a position such that the seal connected to the first plug portion is aligned with a first interior wall and the second biasing member biases the movable wall member to a position such that the seal connected to the outer surface of the movable wall member is compressed against a contact surface.

2. The conduit coupling of claim 1 wherein when the first portion and second portion are disconnected, an interior contact wall located on the movable wall member can move to become aligned with a seal connected to a second plug portion, the second plug portion being in contact with the first plug portion when the first portion and second portion are connected.

3. The conduit coupling of claim 1 wherein the contact surface is diagonally disposed with respect to a direction of movement of the moveable wall member.

4. The conduit coupling of claim 1 wherein the seal connected to the outer surface of the moveable wall member is wedged between two facing walls, with one of the two facing walls extending further outward in a radial direction than the other of the two facing walls.

5. The conduit coupling of claim 1 wherein when the first portion is connected to the second portion, the first plug portion is in contact with a second plug portion, and wherein when the first portion is retracted from the second portion to disconnect the portions, the first plug portion stays in contact with a second plug portion until the seal connected to the first plug portion is aligned with the first interior wall and the interior contact wall of the movable wall member is aligned with a seal connected to the second plug portion.

6. The conduit coupling of claim 5 wherein when the first plug portion is in contact with the second plug portion, a protrusion on the second plug portion is snugly fitted within a recess on the first plug portion.

7. The conduit coupling of claim 1 wherein the movable wall member is cylindrically shaped and wherein a hollow shaft is concentrically positioned within at least a portion of the movable wall member.

8. A conduit coupling for a fluid comprising:
a male portion having a first fluid chamber;
a first coil spring disposed within an internal wall of the first fluid chamber;
a movable channel member adjacent an end portion of the first coil spring;
a moveable plug portion connected to the movable channel member;
a seal connected to a circumferential perimeter of the moveable plug portion;
a female portion releasably connectable to the male portion and including a second fluid chamber;
a stationary hollow shaft forming part of the second fluid chamber, the hallow shaft being concentrically disposed within a second coil spring;
a stationary plug portion connected to the hollow shaft;
a movable wall member disposed adjacent an end portion of the second coil spring, the moveable wall member being movable relative to the stationary hollow shaft when biased by the second coil spring; and
an annular seal connected to an outer wall of the moveable wall member, the annular seal being wedged between a first lateral wall and a second lateral wall, the second lateral wall extending radially further than the first lateral wall.

9. The conduit coupling of claim 8 wherein when the male portion is disconnected from the female portion, the annular seal connected to the outer wall of the movable wall member can be compressed against a contact surface by a biasing force of the second coil spring.

10. The conduit coupling of claim 8 wherein when the male portion is disconnected from the female portion, the movable plug portion is biased to a position in which the seal connected to the moveable plug portion is in contact with an inside wall of an entrance lip of the male portion.

11. The conduit coupling of claim 8 wherein when the male portion is disconnected from the female portion, the movable wall member is biased to a position such that an interior contact wall on the movable wall member comes into contact with a seal positioned on the stationary plug portion.

12. The conduit coupling of claim 8 wherein when the male portion is connected to the female portion, the movable plug portion and the stationary plug portion are in contact, and when the male portion is being retracted from the female portion, the moveable plug portion stays in contact with the stationary plug portion until the seal connected to the movable plug portion becomes aligned with and compressed against a wall and a seal connected to the stationary plug portion becomes aligned with and compressed against a wall.

13. The conduit coupling of claim 8 wherein the moveable plug portion is connected by at least one strip to a retainer, with the retainer being disposed adjacent the first coil spring.

14. The conduit coupling of claim 8 wherein a recess formed on a flat surface of the moveable plug portion is configured to receive a protrusion formed on a flat surface of the stationary plug portion.

15. The conduit coupling of claim 8 further comprising a plurality of non-linear tracks on the female portion.

16. The conduit coupling of claim 15 further comprising corresponding stubs formed on the male portion that are insertable into the tracks on the female portion and movable in a non-linear fashion within the tracks to lock the male portion in a connected position with the female portion.

17. A method of sealing liquid within portions of a disconnectable conduit coupling, the method comprising:
providing a first coupling portion having a first biasing member;
compressing the first biasing member in the first coupling portion to connect the first coupling portion to a second coupling portion by pressing a stationary plug of the second coupling portion flush against a movable plug of the first coupling portion that is movable in relation to the first coupling portion;
compressing a second biasing member in the second coupling portion to connect the second coupling portion to the first coupling portion by pressing a surface of the first coupling portion against a moveable wall of the second coupling portion, the moveable wall being slidable in relation to the second coupling portion; and
disconnecting the second coupling portion from the first coupling portion, and maintaining flush contact between the movable plug and stationary plug until a seal member connected to an outer surface of the movable wall is compressed against a contact surface on the second coupling portion and until a seal member connected to the movable plug portion is compressed against an inside wall of the first coupling portion.

18. The method of claim 17 wherein the seal member connected to the outer surface of the moveable wall member is retained within a recess having parallel walls of uneven length.

19. The method of claim 17 wherein when the seal member connected to an outer surface of the moveable wall is compressed, a seal member connected to the stationary plug is also compressed by being in contact with a wall.

20. The method of claim 19 wherein disconnecting the second coupling portion from the first coupling portion further comprises pushing the coupling portions together to displace a stub formed on the male portion from a resting gap formed on the female portion.
